(19) United States
(12) Patent Application Publication
(10) Pub. No.: US 2010/0223462 A1
(43) Pub. Date: Sep. 2, 2010

(54) METHOD AND DEVICE FOR ACCESSING SERVICES AND FILES

(75) Inventors: Thanh Van Do, Oslo (NO); Thuan Van Do, Oslo (NO); Ivar Jorstad, Oslo (NO)

Correspondence Address: SCHNECK & SCHNECK, P.O. BOX 2-E, SAN JOSE, CA, 95109-0005, US

(73) Assignee: TELENOR ASA, Fornebu (NO)

(21) Appl. No.: 11/909,420

(22) PCT Filed: Mar. 21, 2006
(86) PCT No.: PCT/NO06/00108

§ 371 Date: Nov. 20, 2007

(30) Foreign Application Priority Data
Mar. 21, 2005 (NO) 20051487

(51) Int. Cl. H04L 29/06; H04L 29/08

(52) U.S. Cl. 713/165; 726/11

(57) ABSTRACT

The present invention relates to a method and device for accessing services and files on a computer (4) in a home network (1) from a stationary or mobile device (8, 9) outside said local network Said local network is equipped with a networked file system, and said stationary or mobile device is able to communicate with said local network over a wide area network. For any networked file system message that is to be transmitted over said wide area network, at least some fields of said networked file system message are mapped into corresponding fields in an XML message representing said networked system message. Any XML message that is received over said wide area network, said XML message is parsed, and if said XML message represents a networked file system message, a networked file system message is reconstructed by mapping each field of said XML message into a corresponding field of said reconstructed networked file message.

### FIELD OF THE INVENTION

The present invention relates to data communication systems, and in particular the access and use of files and services residing on a local network computer system from remote computers, Personal Digital Assistants (PDA) or mobile phones.

### TECHNICAL BACKGROUND

Nowadays, more and more households are acquiring broadband Internet connections to their home. On the home local network they may have several computers running various services and hosting private documents and files. It is hence quite desirable to be able to access these services and files from outside their home via stationary computers is or mobile devices like cellular phone or PDA.

Unfortunately, to be connected to the Internet does not bring only advantages but also drawbacks. The user home networks as other networks connected to the Internet are exposed to fraudulent attacks and misuses. For protection against frauds and intrusions, more and more users are installing firewalls. While protecting the user home network, the firewalls may also prevent the legitimate users to access their files and services located on the user home network.

In order to establish a secure connection to a local network from outside, solutions such as Virtual Private Networks (VPN) can be used. The firewall of the local network is configured to also operate as a VPN server, and the mobile device could be used as a VPN client to connect to this VPN server. Having connected to this server, the mobile device becomes part of the local network that resides behind the firewall/VPN server. This Virtual Network (realised with an encrypted tunnel) will allow traffic of any service to flow back and forth between the local network and the mobile device.

The VPN solution has, however, many limitations. The VPN solution requires high resource consumption in terms of processing power and network bandwidth, which is usually not available in mobile devices and wireless networks.

Another drawback is that it takes times to start up a VPN and it does time out when there is no activity. This is not convenient for the mobile user that sporadically accesses his home network.

These limitations call for a simplified solution which can adapt to both user's technical skills and the resource constraints in networks and devices.

### SUMMARY OF THE INVENTION

The present invention provides a solution for accessing services and files residing on a computer in a local network from stationary or mobile devices outside said local network without compromising security.

The invention requires only minimal technical skills to take into use. All that is needed is to download and install an application on the computer where services reside (in the home network), as well as to download and install a client on the device in use.

In addition, the invention allows several (all) computers on the local network to provide services, thus every person having their own computer can access their own personal services from their mobile device.

The scope of the invention appears from the appended patent claims.

In particular, the present invention relates to a method for providing access to services and files on a computer in a local network from a stationary or mobile device outside said local network. Said local network is equipped with a networked file system, and said stationary or mobile device is able to communicate with said local network over a wide area network. For any networked file system message that is to be transmitted over said wide area network, at least some fields of said networked file system message are mapped into corresponding fields in an XML message representing said networked system message. Any XML message that is received over said wide area network, said XML message is parsed, and if said XML message represents a networked file system message, a networked file system message is reconstructed by mapping each field of said XML message into a corresponding field of said reconstructed networked file message.

The invention also relates to a device for providing access to services and files on a computer in a local network, from a stationary or mobile device outside said local network. Said local network is equipped with a networked file system, and said stationary or mobile device is connected to said local network over a wide area network. Said device is adapted to map at least some fields of a networked file system message to be transmitted over said wide area network into corresponding fields in an XML message representing said networked file system message. Said device is further adapted to parse a XML message received over said wide area network, and if said XML message represents a networked file system message to reconstruct a networked file system message by mapping each field of said XML message into a corresponding field of said reconstructed networked file message.

### BRIEF DESCRIPTION OF THE DRAWINGS

The invention will now be described in detail in reference to the appended drawings, in which:

FIG. 1 illustrates the overall architecture of a mobile home access system according to the present invention,

FIG. 2 shows a solution for a local network with dynamic global IP address,

FIGS. 3 and 4 shows a solution for a local network with permanent or dynamic local IP address,

FIG. 5 shows the interfaces of the home access local Web service according to the invention,

FIG. 6 is a sequence diagram illustrating how one request from a home access Web service client invokes several requests and responses between the home access local Web service and the file system,

FIG. 7 is a sequence diagram showing the messages passing using the authentication interfaces.

### DETAILED DESCRIPTION

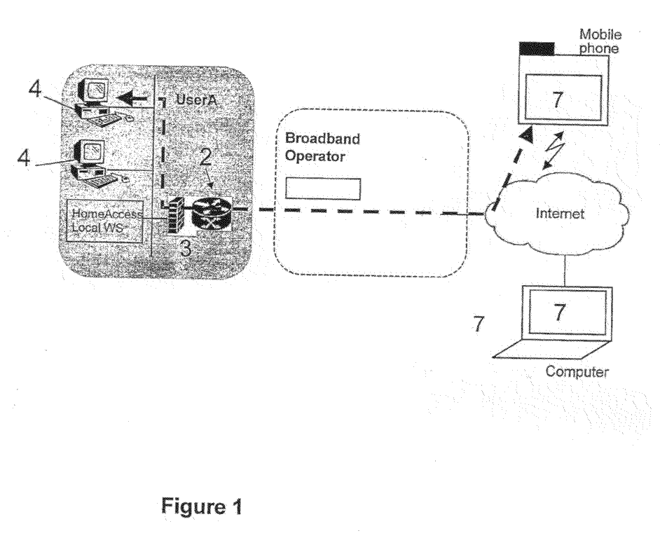

FIG. 1 depicts a typical home broadband connection to the Internet. The underlying network technologies can be xDSLs or cable TV. As shown in FIG. 1, a local network 1 may comprise several computers 4 and devices. It is connected to a broadband router 2, e.g an ADSL terminating Unit Router (ATU-R), which may provide DHCP and NAT (Network Address Translation). A firewall 3 should be installed to protect the network 1 against intruders. Such a firewall 3 can also be incorporated in the broadband router 2 or LAN/WLAN router. The broadband router 2 is its turn connected to a multiplexer, e.g. Digital Subscriber Loop Access Multiplexer (DSLAM). As shown in FIG. 1, both DHCP and NAT functions may also be carried out in the broadband operator network.

The solution according to the present invention will allow access to any files or services residing on computers 4 on a LAN 1 behind a firewall 3, typically a private Local Area Network (LAN). The solution as shown FIG. 1 consists of three components:
A Home Access Local Web Service 5 that is installed on the PC to provide access to files and services
A Home Access Global Web Service 6 addressable by a global IP address
A Home Access Web Service Client 7 that is installed on the terminal(s) 8, 9 used to access files and services

Based on the nature of the local network IP address, there are four different configurations:

Case 1: Local Network using Permanent Global IP Address

In this case, the Mobile Access to local network solution does require only two components:
Home Access Local Web Service 5
Home Access Web Service client 7

The Home Access Web Service client 7 interacts with the Home Access Local Web Service 5 to allow the user to access his files and services on his local network.

Case 2: Local Network using Dynamic Global IP Address

In this case, the Mobile Home Access requires all the three components:
Home Access Local Web Service 5
Home Access Global Web Service 6
Home Access Web Service Client 7

The Home Access Local Web Service 5, in addition to the functions as described in case 1 must be equipped with the following functions:
IP address discovery and updating
The Home Access Web Service Client 7 must be equipped with the following function:
Home Access Local Web Service discovery

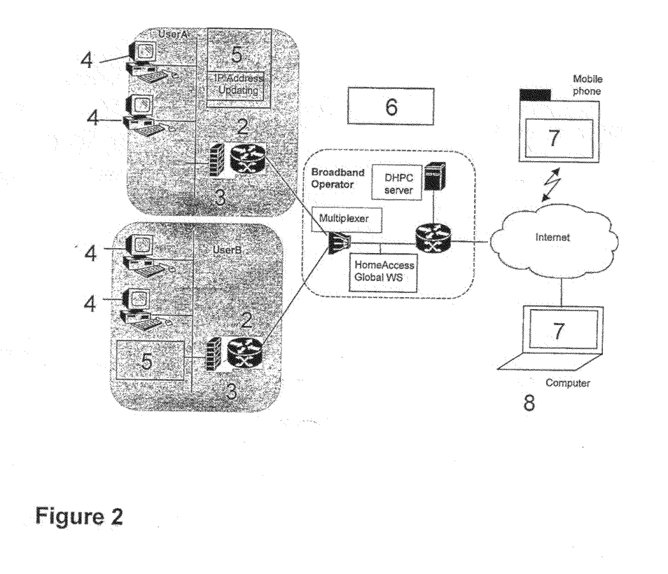

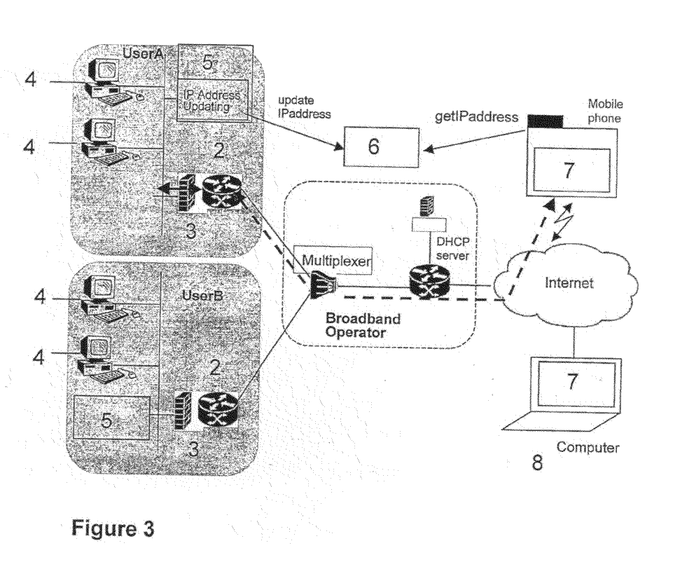

As shown in FIG. 2 the Home Access Local Web Service 5 is communicating with the Home Access Global Web Service 6 to update its current IP address. The Home Access Web Service Client 7 can then interact directly with the Home Access Local Web Service 5 to access the files and services on the local network.

Case 3: Local Network using Permanent Local IP Address

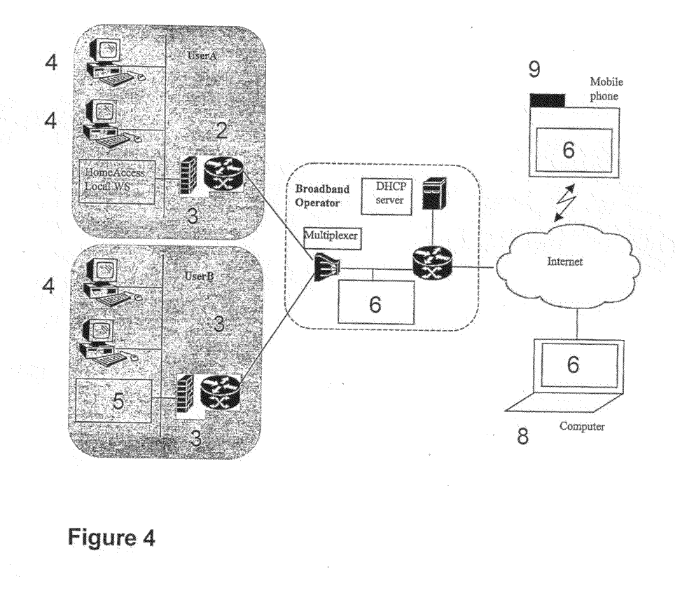

In this case, illustrated in FIG. 4, the Mobile Home Access requires all the three components as in case 2. However, the Home Access Global Web Service 6 must be located in the broadband operator domain. It has the same interfaces as the previously described Home Access Global Web Service 6, but in addition it provides the same interface for file and service access as the Home Access Local Web Service 5.

To access a file or a service located on his local network 1, the user issues a command to the Home Access Web Service Client 7. The Client 7 will invoke the appropriate method on the Home Access Global Web Service 6, which has a permanent URI. Some of the input parameters should be subscriber id and password.

Upon successful authentication, the Home Access Global Web Service 6 will invoke appropriate methods on the Home Access Local Web Service 5 residing on the user's local network 1. It is worth noting that the Home Access Global Web Service 6 must know the local network's IP address and use it to invoke methods on the Home Access Local Web Service 5. The approach for acquiring the Home Access Local Web Service IP address is the same as previously described in case 2.

Case 4: Local Network using Dynamic Local IP Address

In this case, also illustrated by the FIG. 4 drawing, the solution has a configuration which is similar to the case 3. The Home Access Global Web Service 6 needs to find the current IP address of the local network 1 which is now dynamically allocated.

Functionality of the Components

Home Access Local Web Service

The role of the Home Access Local WS 5 is to expose the relevant operations of the native file system on the World Wide Web such a mobile client 8, 9 can use them to access files and services located within the local network 1.

As shown in FIG. 4, the Home Access Local Web Service 5 has three interfaces:
The Native File interface 10
The Web Service File interface 11
The Administrative interface 12

In addition to the file access functionality the Home Access Local Web Service 5 has also the functionality to periodically query the IP address of the local network 1 and uploads it to the Home Access Global Web Service 6 or a defined globally accessible storage area.

The Native File Interface

At the local network, there could be several users sharing several heterogeneous computers and peripheral devices. It is assumed that the local network is equipped with a networked file system that allows the users to view and to access remote files located on other computers from one computer. Examples of such a networked file system can be Sun Network File System (NFS) [1] [2] or Common Internet File System (CIFS) [3]. However, only CIFS will be considered further since it is incorporated in Microsoft Windows that are installed in most private households.

CIFS is a file sharing protocol. Client systems use this protocol to request file access services from server systems over a network. It is based on the Server Message Block (SMB) protocol widely in use by personal computers and workstations running a wide variety of operating systems.

The protocol supports the following features:
File access
File and record locking
Safe caching, read-ahead, and write-behind
File change notification
Protocol version negotiation
Extended attributes
Distributed replicated virtual volumes
Server name resolution independence
Batched requests
Unicode file names

Although CIFS is independent of the transport layer, the common transports today across this interface is through NBT (NetBIOS over TCP) or across raw TCP connections.

Raw TCP Transport

This mode of operation is the simplest, where SMB messages can be sent immediately to port 445 on the server. Based on the response to a TCP connection request to this port, and possibly a reply to the SMB message, either RAW transport can used further or an NBT session can be initiated as described below.

NBT Transport

In this mode, additional messages must be sent to gain access to the file server and to initiate a session. Also, a valid NetBIOS name of the file server is needed in the message that requests a new session. The need for NBT support completely relies on the servers that should be supported and whether these are expecting correct NBT semantics.

The Web Service File Interface

Since the goal is to enable file and service access from outside devices, especially mobile phones, which have several limitations, the requirements on the Web Service Interface are as follows:
It should support both regular computers and limited mobile devices
It should be capable to adapt itself to the device type
For mobile phones with physical limitations in terms of storage, processing, small display, etc. the operations/methods should be rich such that only few operations are required to accomplish a task.

To cope with these requirements the Web Service File Interface consists of the following sub-interfaces:
Authentication Interface
Administration Interface
Tunnelling Interface
Reduced Mapping interface

Before allowing access to home files and services, it is important that the identification, authentication and authorisation are carried out properly. The Web Service File Interface must have an Authentication Interface.

The Tunnelling Interface is more suitable for access from remote personal computer, which has a CIFS client installed. The Reduced Mapping Interface is intended formobile devices with limited capabilities.

Authentication Interface

This interface controls identification, authentication and authorization to shared resources.

IAUTHMustAuthenticate(Challenge)—This method is used to notify the client that it is required to authenticate itself prior to accessing any resources through the service access point. This method can be used as a response to any type of request from an unauthenticated client.

IAUTHAuthenticateReguest(Credentials)—This method is used by the client to request authentication by providing proper credentials.

IAUTHAuthenticateResponse( )—This method is used by the service access point to notify the client about the outcome of the authentication process.

The Administrative Interface

Access to administration methods requires successful authentication through the interface described earlier. The administrative interface can be used both from remote clients as well as from clients on the local network which could be an administration application.

The Administrative Interface allows a user to specify:
What directories on the home computer(s) should be made accessible to remote devices

In addition it allows a System Administrator to configure:
User accounts

IADMListHosts( )—Lists all hosts on the local network

IADMListUsers( )—Lists all registered users

IADMListDirectoriesOnHost(String host)—Lists all accessible directories on the specified host

IADMSetAccessRights(URI resource, Int accessrights)—Sets the specified access rights on the specified file or directory

IADMGetUserConfiguration(String user id)—Retrieves the specified user's configuration

IADMSetUserConfiguration(String user id, Configuration c)—Sets the specified user's configuration

Each user's access rights to resources and preferences are controlled through two methods (IADMGetUserConfiguration and IADMSetUserConfiguration). By defining a generic method which passes the configuration as a parameter to the Home Access Local Web Service, maximum flexibility is achieved, and new features can easily be added later on.

A Configuration contains at least the following definitions:
1. Definition of access rights (readable, writable or both) to specific files and directories
2. For each resource it should be possible to define which component of the resource is available (offset, length etc.)
3. Definition of access rights and format/presentation from specific device or group of devices
4. Definition of access rights from specific IP-addresses, subnets or domains
5. Definition of access rights by specific users and groups of users

Tunnelling Interface

In tunnelling mode, a complete CIFS message is encapsulated in a Simple Object Access Protocol (SOAP) message by the Home Access Local Web Service using binary attachments. At the Web Service client side (on the terminal), the CIFS content is extracted from the SOAP message and exposed through a CIFS server. This way, an ordinary CIFS enabled browser (e.g. Windows Explorer) can be used to access the remote file system.

There are basically two approaches to embedding binary data into SOAP messages.

The first approach is to use the XML CDATA element type for embedding the CIFS message into the XML message. The drawback of this solution is that the data must be base64 encoded to avoid the content conflicting with e.g. the terminating CDATA tag. Using base64 encoding results in an increase in size of ⅓ of the original size. For SMB messages containing only signalling information, this might not be a problem, but for the messages containing file contents it is.

The other approach is to use SOAP with Attachments (SwA) [4][5][6], but this is not yet supported by all SOAP platforms. It is however supported with JAX-RPC [7] through SAAJ [8]. SwA will, utilising one of the referenced specifications, be supported by all SOAP platforms in the near future.

Also, the client application exposing the file system is required to authenticate itself towards the service access point before access to the remote file system is granted and the file system can be exposed. Except for this authentication process, all other commands follow the network file system protocol.

The Tunnelling Interface has two methods:

ITUNReqCommand(CIFSAttachment)—Transports a complete request command from client to host with network file system

ITUNResCommand(CIFSAttachment)—Transports a complete response command from host with network file system to client

Reduced Mapping Interface

Every CIFS message can be replaced by a corresponding SOAP message. In theory, each field of a CIFS message could be mapped into an entry of a SOAP message by the Home Access Local Web Service. At the client side (terminal), the SOAP message is parsed and the original CIFS message reconstructed and exposed through a CIFS server. However, such a full mapping scheme introduces a lot of overhead and it is not sure that the mobile device is capable to receive and process all the data that it gets. A reduced mapping scheme is more efficient and has the following advantages:
Reduces the content of each message
Reduces the number of total messages
Reduces the requirements on the mobile device; there is no need for a complete CIFS client on the device, but only a client which supports the specified methods.

Only the most important parts of native network file system messages are mapped to an XML format. In addition, a set of management interfaces that are used between the client and the service access point, are defined.

These interfaces control connection establishment towards shares, as well as maintenance of sessions and teardown of connections.

IACCListResources(URI uri, String pattern, Boolean recursive)—Lists all resources on the specified URI matching the specified pattern. If pattern is left empty, all resources on the specified URI are listed. Setting recursive to true allows this method to be used for searching for specific named resources throughout the entire tree defined by uri.

IACCReadResource(URI uri)—Reads the contents of the specified resource as specified in the user configuration described previously. This method incorporates several methods of the network file system, such as protocol negotiation, session setup etc., see the enclosed example.

IACCWriteResource(URI uri, WriteSpecification ws)—Writes to the specified resource the content specified by ws (e.g. create/offset/append, data, length etc.). This method incorporates several methods of the network file system, such as protocol negotiation, session setup etc., see the enclosed example.

Home Access Global Web Service

The Home Access Global Web Service is required for the three cases:
Dynamic global IP address
Permanent local IP address
Dynamic local IP address.

It is collaborating with several Home Access Local Web Services belonging to different users. It must have a list of users to serve. Before establishing the connection of a Home Access Local Web Service of a user, sufficiently strong authentication must be carried out.

It has the following functionality:
Discovery and updating of the local network current IP address
Relaying the method requests from the Home Access Web Service Client to the Home Access Local Web Service.

It has the following interfaces:
The Native File interface
The Web Service File interface
The IP update interface

The two first interfaces are the same as the ones defined for the Home Access Local Service.

The IP update interface has the following method:

IUpdateIP(user_id, IP address)—To update the IP address of the specified user

IGetCurrentIP(user_id)—Returns the current IP address of the specified user

Home Access Web Service Client

There are two types of Home Access Web Service Client:
Tunnelling Client
Reduced Mapping Client

The Tunnelling Client will use the Tunnelling Interface to interact with either the Home Access Local Web Service or the Home Access Global Web Service. This Client is suitable for regular PCs. It incorporates also a CIFS server such that a regular CIFS client like Windows Explorer can be used to access the remote files and services.

The Reduced Mapping Client will use the Reduced Mapping Interface to interact with the Home Access Local Web Service and Home Access Global Web Service. This Client is suitable for mobile devices such as mobile phones or PDA (Personal Digital Assistant). It incorporates also a file browser and a User interface (UI) which are designed for devices with limited display and navigation ability.

### Example

### Reduced Mapping Interface—Message Reduction

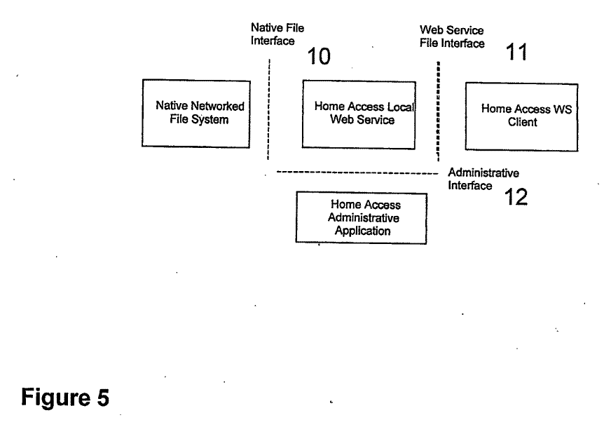

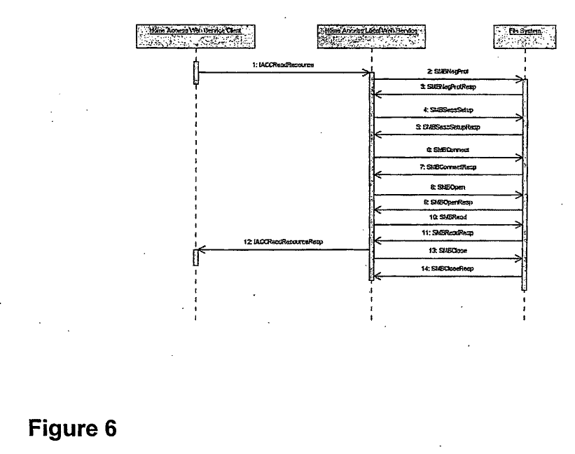

As FIG. 5 displays, the Reduced Mapping Interface decreases the number of messages travelling over the network between the mobile device and the local network.

The previous sections of this document have described the generic interfaces necessary to expose a file system on a LAN behind a router/firewall to remote hosts through an XML Web Service. This example details how this can be done using the Common Internet File System (CIFS) as a network file system on the LAN.

This example will provide XML Schema Definitions (XSDs) for transforming CIFS messages into appropriate SOAP messages.

The namespace for all schemas should be http://www.ongx.org/CIFS2XML.

Common Interfaces

This section defines the interfaces that are shared between all modes of operation.

Authentication Interface

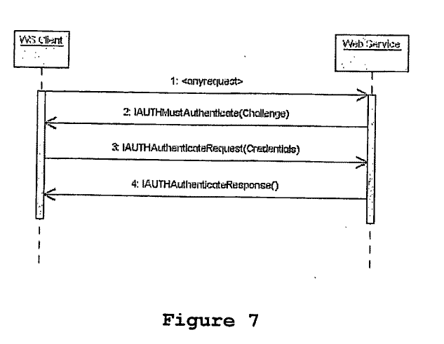

The parameters in the following messages employ the Digest Authentication mechanisms described in RFC2617 [9]. This is for illustrative purposes only and other (stronger) authentication mechanisms could/should be employed. The message exchange described below is illustrated in FIG. 7.

IAUTHMustAuthenticate(Challenge)

The XSD for this message is defined in IAUTHMustAuthenticate.xsd as (and in this case represents the RFC2617 WWW-Authenticate request):

```
<?xml version=“1.0” encoding=“ISO-8859-1” ?>
  <xs:schema xmlns:xs=“http://www.ongx.org/CIFS2XML”>
        <xs:element name=“IAUTHMustAuthenticate”>
              <xs:complexType>
                    <xs:sequence>
                          <xs:element name=”realm”
                          type=”xs:string”/>
                          <xs:element name=”nonce”
                          type=”xs:string”/>
                          </xs:sequence>
              </xs:complexType>
        </xs:element>
  </xs:schema>
```

IAUTHAuthenticateRequest(Credentials)

The XSD for this message is defined in IAUTHAuthenticateRequest.xsd as (and in this case represents the RFC2617 Authorisation request):

```
<?xml version=“1.0” encoding=“ISO-8859-1” ?>
  <xs:schema xmlns:xs=“http://www.ongx.org/CIFS2XML”>
        <xs:element name=“IAUTHAuthenticateRequest”>
              <xs:complexType>
                    <xs:sequence>
                      <xs:element  name=“username”
type=“xs:string”/>
                      <xs:element name=“realm” type=“xs:string”/>
                      <xs:element name=“nonce” type=“xs:string”/>
                    <xs:element name=“uri” type=“xs:anyURI”/>
                    <xs:element name=“response” type=“xs:string”/>
                        </xs:sequence>
              </xs:complexType>
        </xs:element>
  </xs:schema>
```

IAUTHAuthenticateResponse( )

The XSD for this message is defined in IAUTHAuthenticateResponse.xsd as:

```
<?xml version=“1.0” encoding=“ISO-8859-1” ?>
  <xs:schema xmlns:xs=“http://www.ongx.org/CIFS2XML”>
        <xs:element name=“IAUTHAuthenticateResponse”>
              <xs:complexType>
                    <xs:sequence>
                          <xs:element name=”result”
                          type=”xs:boolean”/>
                          </xs:sequence>
              </xs:complexType>
        </xs:element>
  </xs:schema>
```

Tunnelling Mode

In tunnelling mode, a complete binary CIFS message is attached to a SOAP message. In addition to the binary part, the SOAP header must also be present to denote the type of attachment that is included (i.e., a CIFS message) and its identifier (according to the SOAP 1.2 with Attachments defined by World Wide Web Consortium [3]).

```
<?xml version=“1.0” encoding=“ISO-8859-1” ?>
      <xs:schema xmlns:xs=“http://www.ongx.org/CIFS2XML”>
                  xmlns:ref=“http://ws-i.org/profiles/basic/1.1/xsd”
            <xs:element name=“SMBMessage”>
                  <xs:complexType>
                        <xs:sequence>
                              <xs:element name=”message”
                              type=”ref:swaRef” use=”required”/>
                  </xs:sequence>
            </xs:complexType>
      </xs:element>
</xs:schema>
```

By making the SMBMessage element a complexType, additional information can be added later on if needed.

A SOAP message with a CIFS message attached would look like this:

```
MIME-Version: 1.0
Content-Type: Multipart/Related; boundary=MIME_boundary;
type=text/xml;
        start=“<access2home.xml@ongx.org>”
Content-Description: SOAP message with SMB message
attached.
--MIME_boundary
Content-Type: text/xml; charset=UTF-8
Content-Transfer-Encoding: 8bit
Content-ID: <access2home.xml@ongx.org>
<?xml version=‘1.0’ ?>
<SOAP-ENV:Envelope
xmlns:SOAP-ENV=“http://schemas.xmlsoap.org/soap/envelope/”>
xmlns:SMB=“http://www.ongx.org/CIFS2XML”
<SOAP-ENV:Body>
      <SMB:SMBMessage>
            <message>cid:SMBMessage.MobileAccess1234@ongx.org
</message>
      </SMB:SMBMessage>
</SOAP-ENV:Body>
</SOAP-ENV:Envelope>
--MIME_boundary
Content-Type: application/octet-stream
Content-Transfer-Encoding: binary
Content-ID: <SMBMessage.MobileAccess1234@ongx.org>
...binary SMB message...
--MIME_boundary-
```

The cid value in the Message element refers to the Content-ID tag in the second MIME boundary, and should be unique for each SOAP message. It might be necessary to add a pseudo-random value to this identifier to allow several CIFS messages to be attached to one SOAP message.

Reduced Mapping Mode

Content-type for attachments (i.e., file contents) must be application/octet-stream. In addition, the SOAP envelope must contain the *real* MIME type of the file being transferred to allow proper handling of the attachment on the receiver end (e.g. determine which program should be used to open it). Unless this is decided based on the file extension (e.g. *.jpg etc.).

<AttachmentRealMIMEType>image/jpeg</AttachmentRealMIMEType>< . . . Description of each element in the messages . . . >

Administration Interfaces

a. IADMListHOsts( )

The request message in this interface must conform to IADMListHostsRequest.xsd:

<?xml version=“1.0” encoding=“ISO-8859-1” ?>
<xs:schema xmlns:xs=“http://www.ongx.org/CIFS2XML”>
<xs:element name=“IADMListHostsRequest”/>
</xs:schema>

A response must conform to IADMListHostsResponse.xsd:

```
<?xml version=“1.0” encoding=“ISO-8859-1” ?>
  <xs:schema xmlns:xs=“http://www.ongx.org/CIFS2XML”>
        <xs:element name=“IADMListHostsResponse”>
              <xs:complexType>
                    <xs:sequence>
                          <xs:element name=”host” type=”xs:string”
                          minOccurs=”0” max=”unbounded”/>
              </xs:sequence>
              </xs:complexType>
        </xs:element>
  </xs:schema>
```

b. IADMListUsers( )

A request must conform to IADMListUsersRequest.xsd:

<?xml version=“1.0” encoding=“ISO-8859-1” ?>
<xs:schema xmlns:xs=“http://www.ongx.org/CIFS2XML”>
<xs:element name=“IADMListUsersRequest”/>
</xs:schema>

A response must conform to IADMListUsersResponse.xsd:

```
<?xml version=“1.0” encoding=“ISO-8859-1” ?>
<xs:schema xmlns:xs=“http://www.ongx.org/CIFS2XML”>
    <xs:element name=“IADMListUsersResponse”>
        <xs:complexType>
            <xs:sequence>
                <xs:element name=”User” type=”xs:string”
                minOccurs=”0” max=”unbounded”/>
        </xs:sequence>
        </xs:complexType>
    </xs:element>
</xs:schema>
```

IADMListDirectoriesOnHost(Host)

A request must conform to IADMListDirectoriesOnHostRequest.xsd:

```
  <?xml version=“1.0” encoding=“ISO-8859-1” ?>
  <xs:schema xmlns:xs=“http://www.ongx.org/CIFS2XML”>
      <xs:element name=“IADMListDirectoriesOnHostRequest”>
          <xs:element name=”host” type=”xs:string”/>
      </xs:element>
</xs:schema>
```

A response must conform to IADMListSharesOnHostResponse.xsd:

```
<?xml version=“1.0” encoding=“ISO-8859-1” ?>
<xs:schema xmlns:xs=“http://www.ongx.org/CIFS2XML”>
      <xs:element name=“IADMListDirectoriesOnHostResponse”>
        <xs:complexType>
            <xs:sequence>
                <xs:element name=”directory”
                type=”xs:string” minOccurs=”0”
                max=”unbounded”/>
        </xs:sequence>
        </xs:complexType>
    </xs:element>
</xs:schema>
```

d. IADMSetAccessRights(URI resource, Int accessrights)

A request must conform to IADMSetAccessRightsRequest.xsd:

```
  <?xml version=“1.0” encoding=“ISO-8859-1” ?>
  <xs:schema xmlns:xs=“http://www.ongx.org/CIFS2XML”>
      <xs:element name=“IADMSetAccessRightsRequest”>
          <xs:element name=”resource” type=”xs:anyURI”/>
          <xs:element name=”accessrights” type=”xs:int”/>
      </xs:element>
</xs:schema>
```

A response must conform to IADMSetAccessRightsResponse.xsd:

```
  <?xml version=“1.0” encoding=“ISO-8859-1” ?>
  <xs:schema xmlns:xs=“http://www.ongx.org/CIFS2XML”>
      <xs:element name=“IADMGetUserconfigurationResponse”>
          <xs:element name=”result” type=”xs:boolean”/>
      </xs:element>
</xs:schema>
```

e. IADMGetUserConfiguration(User)

A request most conform to IADMGetUserConfigurationRequest.xsd:

```
    <?xml version=“1.0” encoding=“ISO-8859-1” ?>
    <xs:schema xmlns:xs=“http://www.ongx.org/CIFS2XML”>
    <xs:element name=“IADMGetUserConfigurationRequest”>
        <xs:element name=”user_id” type=”xs:string”/>
    </xs:element>
</xs:schema>
```

A response must conform to IADMGetUserConfigurationResponse.xsd:

```
<?xml version=“1.0” encoding=“ISO-8859-1” ?>
    <xs:schema xmlns:xs=“http://www.ongx.org/CIFS2XML”>
    <xs:element name=“IADMGetUserConfigurationResponse”>
        <xs:element name=”configuration” type=”xs:configuration”/>
    </xs:element>
</xs:schema>
```

f. IADMSetUserConfiguration(String user_id, Configuration c)

A request most conform to IADMSetUserConfigurationRequest.xsd:

```
<?xml version=“1.0” encoding=“ISO-8859-1” ?>
    <xs:schema xmlns:xs=“http://www.ongx.org/CIFS2XML”>
    <xs:element name=“IADMGetUserConfigurationRequest”>
        <xs:complextype>
            <xs:sequence>
                <xs:element name=”user_id” type=”xs:string”/>
                    <xs:element name=”configuration”
                    type=”xs:configuration”/>
            </xs:sequence>
        </xs:complextype>
    </xs:element>
</xs:schema>
```

A response must conform to IADMGetUserConfigurationResponse.xsd:

```
<?xml version=“1.0” encoding=“ISO-8859-1” ?>
<xs:schema xmlns:xs=“http://www.ongx.org/CIFS2XML”>
    <xs:element name=“IADMSetUserConfigurationResponse”>
        <xs:element name=”result” type=”xs:boolean”/>
    </xs:element>
</xs:schema>
```

Connection Establishment, Maintenance and Teardown interfaces

These functions are transparent to the Home Access Client, and will be performed only by the Home Access Local Web Service. The mapping is thus one-to-one between client calls and file system calls. This is already discussed above.

Resource Access Interfaces

a. IACCListResources(URI uri String pattern, Boolean recursive)

A request on this interface must conform to IACCListResourcesRequest.xsd:

```
<?xml version=“1.0” encoding=“ISO-8859-1” ?>
<xs:schema xmlns:xs=“http://www.ongx.org/CIFS2XML”>
<xs:element name=IACCListResourcesRequest”>
  <xs:complexType>
    <xs:sequence>
            <xs:element name=”uri” type=”xs:anyURI”/>
            <xs:element name=”pattern”
            type=“xs:string”/>
            <xs:element name=”recursive”
            type=”xs:boolean”/>
    </xs:sequence>
  </xs:complexType>
</xs:element>
</xs:schema>
```

A response on this interface must conform to IACCListResourcesResponse.xsd:

```
<?xml version=“1.0” encoding=“ISO-8859-1” ?>
<xs:schema xmlns:xs=“http://www.ongx.org/CIFS2XML”>
<xs:element name=“IACCListResourcesResponse”>
  <xs:complexType>
    <xs:sequence>
            <xs:element name=”resource”
            type=”xs:string” minOccurs=”0”
            max=”unbounded”/>
    </xs:sequence>
  </xs:complexType>
</xs:element>
</xs:schema>
```

b. IACCReadResource(URI uri)

A request on this interface must conform to IACCReadResourceRequest.xsd:

```
<?xml version=“1.0” encoding=“ISO-8859-1” ?>
<xs:schema xmlns:xs=“http://www.ongx.org/CIFS2XML”
<xs:element name=“IACCReadResourceRequest”>
  <xs:complexType>
    <xs:sequence>
            <xs:element name=”uri” type=”xs:anyURI”/>
    </xs:sequence>
  </xs:complexType>
</xs:element>
</xs:schema>
```

A response on this interface must conform to IACCReadResourceResponse.xsd:

```
    <?xml version=“1.0” encoding=“ISO-8859-1” ?>
    <xs:schema xmlns:xs=“http://www.ongx.org/CIFS2XML”
    xmlns:ref=“http://ws-i.org/profiles/basic/1.1/xsd”>
    <xs:element name=“IACCReadResourceResponse”>
      <xs:complexType>
        <xs:sequence>
                <xs:element name=”resource”
                type=”ref:swaRef” use=”required”/>
        </xs:sequence>
      </xs:complexType>
    </xs:element>
</xs:schema>
```

c. IACCWriteResource(URI uri, WriteSpecification ws)

```
    <?xml version=“1.0” encoding=“ISO-8859-1” ?>
    <xs:schema xmlns:xs=“http://www.ongx.org/CIFS2XML”>
    <xs:element name=“IACCWriteResourceRequest”>
      <xs:complexType>
        <xs:sequence>
                <xs:element name=”uri” type=”xs:anyURI”/>
                <xs:element name=”writespecification”
                type=”xs:writespecification”/>
        </xs:sequence>
      </xs:complexType>
    </xs:element>
</xs:schema>
```

A response on this interface must conform to IACCListResourcesResponse.xsd:

```
    <?xml version=“1.0” encoding=“ISO-8859-1” ?>
    <xs:schema xmlns:xs=“http://www.ongx.org/CIFS2XML”>
    <xs:element name=“IACCWriteResourceResponse”>
      <xs:complexType>
        <xs:sequence>
                <xs:element name=”writeresult”
                type=”xs:boolean”/>
        </xs:sequence>
      </xs:complexType>
    </xs:element>
</xs:schema>
```

### Information Sources Included by Reference

[1] Sun Microsystems Inc. (1989). NFS: Network File System Protocol Specification. IETF. March 1989. http://www.ietf.org/rfc/rfc1094.txt?number=1094

[2] Callaghan, B., et.al. (1995). NFS Version 3 Protocol Specification. IETF. June 1995. http://www.ietf.org/rfc/rfc1813.txt?number=1813

[3] Storage Networking Industry Association (SNIA). (2002). Common Internet File System (CIFS) Technical Reference Revision 1.0. February 2002.

[4] Barton, J., et.al. (2000). SOAP Messages with Attachments. World Wide Web Consortium (W3C). December 2002. http://www.w3.org/TR/SOAP-attachments

[5] Gudgin M., et.al. (editors) (2005). SOAP Message Transmission Optimization Mechanism. World Wide Web Consortium (W3C). January 2005. http://www.w3.org/TR/2005/REC-soap12-mtom-20050125/

[6]Ferris, C., et.al. (editors) (2004). Attachments Profile Version 1.0. Web Services Interoperability Organization (WS-i). August 2004. http://www.ws-i.org/Profiles/AttachmentsProfile-1.0-2004-08-24.html

[7] Sun Microsystems, Inc. (2003). JSR-67: Java APIs for XML Messaging 1.0. Java Community Process (JCP). http://www.jcp.org/en/jsr/detail?id=67

[8] Sun Microsystems, Inc. (2003). JSR-101: Java APIs for XML based RPC. Java Community Process (JCP). http://www.jcp.org/en/jsr/detail?id=101

[9] Franks, J., et.al. (1999). HTTP Authentication: Basic and Digest Access Authentication. IETF. June 1999. http://www.ietf.org/rfc/rfc2617.txt?number=2617

1. A method for providing access to services and files on a computer in a local network from a stationary or mobile device outside said local network, said local network being equipped with a networked file system, a firewall and a network address translator, said stationary or mobile device being able to communicate with said local network over a wide area network, comprising, for any networked file system message that is to be transmitted over said wide area network mapping at least some fields of said networked file system message into corresponding fields in an XML message representing said networked system message, and for any XML message received over said wide area network parsing said XML message, and if said XML message represents a networked file system message reconstructing a networked file system message by mapping each field of said XML message into a corresponding field of said reconstructed networked file message.

2. A method as claimed in claim 1 wherein said XML message is a SOAP message.

3. A method as claimed in claim 1 wherein said stationary or mobile device supports a reduced set of XML format messages, and only the most important parts of the networked file system messages.

4. A method as claimed in claim 1 further comprising mapping said networked file system messages into XML format messages using XML Schema Definitions.

5. A method as claimed in claim 1 further comprising providing file content in application/octet-stream format.

6. A method as claimed in claim 1 further comprising providing information regarding MIME type of a file being transferred.

7. A system for providing access to services and files on a computer in a local network from a stationary or mobile device outside said local network, said local network being equipped with a networked file system, a firewall and a network address translator, a stationary or mobile device being connected to said local network over a wide area network, comprising device means for mapping at least some fields of a networked file system message to be transmitted over said wide area network into corresponding fields in an XML message representing said networked file system message, said device means further having means for parsing a XML message received over said wide area network, and if said XML message represents a networked file system message for reconstructing a networked file system message by mapping each field of said XML message into a corresponding field of said reconstructed networked file message.

8. A system as claimed in claim 7 wherein said device means is installed in the local network as a Home Access Local Web service.

9. A system as claimed in claim wherein said device means is installed on said stationary or mobile device as a Home Access Web Services Client, said Home Access Web Services Client being adapted to interact with said Home Access Local Web service to access files and services on the local network.

10. A system as claimed in claim 7 wherein said XML message is a SOAP message.

11. A system as claimed in claim 7 wherein said stationary or mobile device supports a reduced set of XML format messages, and only the most important parts of the networked file system messages.

12. A system as claimed in claim 7further comprising means for mapping networked file system messages into XML format messages using XML SCHEMA Definitions.

13. A system as claimed in claim 7 further comprising means for providing file content in application/octet-stream format.

14. A system as claimed in claim 7 further comprising means for providing information regarding the MIME type of a file being transferred.

15. A system as claimed in claim 7 wherein said networked file system is a Sun Network File System or a Common Internet File System.

16. A system as claimed in claim 9 further comprising a Home Access Global Web Service means addressable by a global IP address, said Home Access Global Web Service for holding the current IP address of the local network.

17. A system as claimed in claim 16 wherein the Home Access Global Web Service means is adapted to relay method requests from the Home Access Web Services Client to the Home Access Local Web Service.

18. A system as claimed in claim 16, wherein said Home Access Local Web Service means is adapted to communicate with the Home Access Global Web Service and update its current IP address.
